(19) United States
(12) Patent Application Publication
(10) Pub. No.: US 2026/0221520 A1
(43) Pub. Date: Jul. 30, 2026

(54) SECONDARY BATTERY AND ELECTRONIC APPARATUS

(71) Applicant: Dongguan Amperex Technology Limited, Dongguan (CN)

(72) Inventor: Dekai FANG, Dongguan (CN)

(73) Assignee: Dongguan Amperex Technology Limited, Dongguan (CN)

(21) Appl. No.: 19/578,099

(22) Filed: Mar. 25, 2026

Related U.S. Application Data
(63) Continuation of application No. PCT/CN2024/121105, filed on Sep. 25, 2024.

(30) Foreign Application Priority Data
Sep. 25, 2023 (CN) 202311249101.8

(51) Int. Cl. H01M 10/0587; H01M 10/42; H01M 50/105

(52) U.S. Cl. CPC H01M 10/0587; H01M 10/4235; H01M 50/105

(57) ABSTRACT

A secondary battery includes a housing and an electrode assembly. The electrode assembly is accommodated in the housing, and the electrode assembly is bent toward a first direction (X). The electrode assembly includes a first electrode plate and a second electrode plate. The first electrode plate includes a first current collector and a first active material layer arranged in a stacked manner, where along a thickness direction of the first electrode plate, the first current collector consists of two surfaces arranged opposite each other, and both surfaces are provided with the first active material. The second electrode plate includes a second current collector and a second active material layer arranged in a stacked manner. Multiple first protrusions are formed on a surface of the first electrode plate, and the multiple first protrusions are located in the first coated region.

### CROSS-REFERENCE TO RELATED APPLICATION

This application is a continuation application of International Patent Application Number PCT/CN2024/121105, filed on Sep. 25, 2024, which claims priority to Chinese Patent Application Number 202311249101.8., filed on Sep. 25, 2023, the contents of which are incorporated herein by reference in their entireties.

### TECHNICAL FIELD

This application relates to the field of energy storage technology, in particular to a secondary battery and an electronic apparatus.

### BACKGROUND

To meet usage requirements, some secondary batteries are designed with a curved structure or an arc-shaped structure, and an electrode assembly within each secondary battery is correspondingly curved or arc-shaped. However, after electrode plates in the electrode assembly are bent, active material particles on the electrode plates are compressed or stretched and then release stress, which easily causes deformation or rebound of the electrode plates, leading to deformation issues such as reduced curvature or flattening of the secondary battery.

### SUMMARY

In view of this, this application provides a secondary battery and an electronic apparatus, aiming to suppress deformation and rebound of electrode plates.

In a first aspect of this application, a secondary battery is provided. The secondary battery includes a housing and an electrode assembly. The electrode assembly is accommodated in the housing, and the electrode assembly is bent toward a first direction. The electrode assembly includes a first electrode plate and a second electrode plate. The first electrode plate includes a first current collector and a first active material layer arranged in a stacked manner, where along a thickness direction of the first electrode plate, the first current collector includes a first surface and a second surface opposite each other. The first current collector includes a first coated region, where the first surface and the second surface of the first coated region are each provided with the first active material layer. The second electrode plate includes a second current collector and a second active material layer arranged in a stacked manner. Multiple first protrusions are formed on a surface of the first electrode plate, and the multiple first protrusions are located in the first coated region.

In the above embodiment, the first protrusions are located in the first coated region, which may disperse the stress of the bent first electrode plate and suppress deformation and rebound of the first electrode plate, thereby helping to maintain the bent shape of the first electrode plate, reducing the risk of generation of large a gap between the first electrode plate and the second electrode plate and generation of black spots in the electrode assembly, and improving the reliability of the electrode assembly. Additionally, the first protrusions suppressing deformation and rebound of the first electrode plate is also conducive to addressing deformation issues such as reduced overall curvature or flattening of the electrode assembly. When the overall curvature of the electrode assembly remains substantially unchanged, the secondary battery is less likely to undergo significant deformation, and a reserved space for a battery compartment accommodating the secondary battery can be reduced, thereby facilitating the installation of the secondary battery and improving the reliability and applicability of the secondary battery.

In some embodiments, along a thickness direction of the second electrode plate, the second current collector includes a third surface and a fourth surface opposite each other, the second current collector includes a second coated region, and the third surface and the fourth surface of the second coated region are each provided with the second active material layer. Multiple second protrusions are formed on a surface of the second electrode plate, and the multiple second protrusions are located in the second coated region.

In the above embodiments, the second protrusions may disperse the stress of the bent second electrode plate, suppressing deformation and rebound of the second electrode plate, thereby helping to maintain the bent shape of the second electrode plate. The tendency of deformation and rebound of both the first electrode plate and the second electrode plate is suppressed, which helps to further reduce the risk of generation of an excessive gap between the first electrode plate and the second electrode plate and the risk of generation of black spots in the electrode assembly, thereby further improving the reliability of the electrode assembly.

In some embodiments, along the first direction, the electrode assembly includes a first portion and a second portion arranged sequentially, and the multiple first protrusions are located in the first coated region of the second portion.

In the above embodiments, the multiple first protrusions are located in the first coated region of the second portion, such that the first protrusions are provided on the first electrode plate closer to a protruding side of the electrode assembly, helping to provide a more significant effect of suppressing flattening of the electrode assembly.

In some embodiments, along the first direction, a thickness of the electrode assembly is D, and a thickness of the second portion is D₁, satisfying 3×D/4≤D₁≤D.

In the above embodiments, when the thickness D₁ of the second portion satisfies the condition 3×D/4≤D₁≤D, the thickness of the electrode assembly occupied by the first electrode plate provided with the first protrusions can be increased, which is conducive to further suppressing deformation of the electrode assembly after bending, thereby reducing the risk of reduced curvature or flattening of the electrode assembly.

In some embodiments, the first protrusions are in one of shapes of dotted protrusions, textured protrusions, and striped protrusions, and/or the second protrusions are in one of shapes of dotted protrusions, textured protrusions, and striped protrusions.

In some embodiments, the shape of the first protrusions is different from the shape of the second protrusions.

In the above embodiments, the shape of the first protrusions is different from the shape of the second protrusions, allowing patterns of the first protrusions and the second protrusions with different shapes to be staggered, which is conducive to increasing the friction between the first electrode plate, the second electrode plate, and a separator, suppressing the risk of slippage of the first electrode plate and the second electrode plate, thereby improving the reliability of the electrode assembly.

In some embodiments, in a flattened state of the first electrode plate, when observed along the first direction, a total area of the multiple first protrusions is S₁, and an area of the first electrode plate is S₂, satisfying: S₁≥0.06×S₂.

In the above embodiments, the total area S₁ of the multiple first protrusions satisfies the condition S₁≥0.06×S₂, which is conducive to enhancing the stress dispersion effect of the multiple first protrusions on the overall stress of the first electrode plate, thereby enhancing the suppression of deformation of the first electrode plate after bending.

In some embodiments, along the first direction, a thickness of the first electrode plate corresponding to the first coated region is T₁, and a height of the first protrusions is H₁, satisfying 0.01×T₁≤H₁≤0.14×T₁.

In the above embodiments, the height H₁ of the first protrusions satisfies the condition 0.01×T₁≤H₁≤0.14×T₁, which is conducive to enhancing the stress dispersion effect of the first protrusions on the first electrode plate, thereby further suppressing deformation of the first electrode plate after bending. Additionally, in some embodiments where the first protrusions are formed through embossing of an embossing roller, satisfying this condition also helps to reduce the risk of damage to the first electrode plate due to excessive pressure applied to the first electrode plate by the embossing roller, or reduce the risk of damage to the first electrode plate due to excessive local deformation.

In some embodiments, a distance between any two adjacent first protrusions is F₁, satisfying 1.5 mm≤F₁≤3 mm.

In the above embodiments, the distance F₁ between any two adjacent first protrusions satisfies the condition 1.5 mm≤F₁≤3 mm, which is conducive to dispersing the stress of the first electrode plate, helping to further suppress deformation of the first electrode plate after bending, and reducing the likelihood of generation of black spots in the electrode assembly.

In some embodiments, when observed along the first direction, a width of the first protrusions is R₁, satisfying R₁≥1 mm.

In the above embodiments, the width R₁ of the first protrusions satisfies the condition R₁≥1 mm, which is conducive to enhancing the stress dispersion effect of the first protrusions on the first electrode plate, thereby further suppressing deformation of the first electrode plate after bending, and reducing the likelihood of generation of black spots in the electrode assembly.

In some embodiments, the first coated region includes a first region provided with the first protrusions; and in a flattened state of the first electrode plate, the first electrode plate has a first boundary line and a second boundary line opposite each other along a second direction, the second direction is perpendicular to the first direction, a minimum distance between the first region and the first boundary line is L₁, and a minimum distance between the first region and the second boundary line is L₂, satisfying: 1 mm≤L₁≤7 mm and 1 mm≤L₂≤7 mm.

In the above embodiments, the minimum distance L₁ between the first region and the first boundary line and the minimum distance L₂ between the first region and the second boundary line satisfy the condition 1 mm≤L₁≤7 mm and 1 mm≤L₂≤7 mm, which is conducive to reducing the risk of the embossing roller pressing onto a cut-off position of the first electrode plate in the second direction, thereby reducing the risk of damage to the first electrode plate.

In some embodiments, the first coated region includes a first region provided with the first protrusions; and in a flattened state of the first electrode plate, the first electrode plate has a third boundary line and a fourth boundary line opposite each other along a third direction, and the first direction, the second direction, and the third direction are perpendicular to each other. A minimum distance between the first region and the third boundary line is L₃, and a minimum distance between the first region and the fourth boundary line is L₄, satisfying: 1 mm≤L₃≤7 mm and 1 mm≤L₄≤7 mm.

In the above embodiments, the minimum distance L₃ between the first region and the third boundary line and the minimum distance L₄ between the first region and the fourth boundary line satisfy the condition 1 mm≤L₃≤7 mm and 1 mm≤L₄≤7 mm, which is conducive to reducing the risk of the embossing roller pressing onto a cut-off position of the first electrode plate in the third direction, thereby reducing the risk of damage to the first electrode plate.

In some embodiments, the first electrode plate is an anode electrode plate, and the second electrode plate is a cathode electrode plate.

In the above embodiments, providing the first protrusions on the surface of the first electrode plate which is an anode helps to provide a more significant effect of suppressing flattening of the electrode assembly.

In some embodiments, along a length direction of the first electrode plate, a total length of the first electrode plate is greater than a total length of the second electrode plate.

In the above embodiments, the total length of the first electrode plate being greater than the total length of the second electrode plate is conducive to reducing the risk of lithium precipitation in the electrode assembly.

In some embodiments, along the first direction, a thickness of the first current collector is P₁, satisfying: 4 um≤P₁≤16 um; a thickness of the second current collector is P₂, satisfying 8 um≤P₂≤16 um; a thickness of the first active material layer is C₁, satisfying 50 um≤C₁≤200 um; and a thickness of the second active material layer is C₂, satisfying 50 um≤C₂≤200 um.

In some embodiments, the first current collector further includes a third coated region, where the first surface of the third coated region is provided with the first active material layer, and the second surface of the third coated region is not provided with the first active material layer. Multiple third protrusions are formed on a surface of the first electrode plate, and the multiple third protrusions are located in the third coated region.

In the above embodiments, the multiple third protrusions are located in the third coated region, which may further disperse the stress of the bent first electrode plate, suppressing deformation and rebound of the first electrode plate, thereby helping to maintain the bent shape of the first electrode plate, reducing the risk of generation of a large gap between the first electrode plate and the second electrode plate and the risk of generation of black spots in the electrode assembly, and improving the reliability of the electrode assembly.

In some embodiments, the housing is a packaging bag.

In a second aspect of this application, an electronic apparatus is provided, where the electronic apparatus includes the secondary battery according to any of the above embodiments.

In the above embodiments, the issue of flattening of the arc-shaped secondary battery is alleviated, which is conducive to improving the reliability of the secondary battery, thereby helping to reduce the reserved space for the battery compartment in the electronic apparatus and also helping to improve the reliability of the electronic apparatus.

The secondary battery in this application includes a housing and an electrode assembly accommodated in the housing, the electrode assembly is bent toward a first direction, and the electrode assembly includes a first electrode plate and a second electrode plate. The first electrode plate includes a first current collector and a first active material layer arranged in a stacked manner, and the second electrode plate includes a second current collector and a second active material layer arranged in a stacked manner. Multiple first protrusions are formed on a surface of the first electrode plate, and the multiple first protrusions are located in the first coated region of the first current collector. In this way, the stress of the bent first electrode plate may be dispersed, suppressing deformation and rebound of the first electrode plate, thereby helping to maintain the bent shape of the first electrode plate, reducing the risk of generation of a large gap between the first electrode plate and the second electrode plate and the risk of generation of black spots in the electrode assembly, and improving the reliability of the electrode assembly.

### DESCRIPTION OF DRAWINGS

FIG. 1 is a cross-sectional view of a secondary battery according to an embodiment of this application.

FIG. 2 is a cross-sectional view of a secondary battery according to another embodiment of this application.

FIG. 3 is a side view of a first electrode plate according to an embodiment of this application.

FIG. 4 is a side view of a second electrode plate according to an embodiment of this application.

FIG. 5 is a cross-sectional view of a secondary battery according to an embodiment of this application.

FIG. 6 is a front view of a first electrode plate according to an embodiment of this application.

FIG. 7 is a front view of a first electrode plate according to another embodiment of this application.

FIG. 8 is a front view of a first electrode plate according to still another embodiment of this application.

FIG. 9 is a front view of a second electrode plate according to an embodiment of this application.

FIG. 10 is a front view of a second electrode plate according to another embodiment of this application.

FIG. 11 is a front view of a second electrode plate according to still another embodiment of this application.

FIG. 12 is a side view of a first electrode plate according to another embodiment of this application.

FIG. 13 is a side view of a second electrode plate according to another embodiment of this application.

FIG. 14 is a schematic diagram of an electronic apparatus according to an embodiment of this application.

Description of reference signs of main component

| | |
|---|---|
| Secondary battery | 100 |
| Housing | 10 |
| Electrode assembly | 20 |
| First portion | 20a |
| Second portion | 20b |
| First electrode plate | 21 |
| First current collector | 211 |
| First surface | 211a |
| Second surface | 211b |
| First coated region | 2111 |
| First region | 211c |
| Third coated region | 2112 |
| First uncoated region | 2113 |
| First active material layer | 212 |
| First protrusions | 213 |
| First recesses | 214 |
| Third protrusions | 215 |
| Third recesses | 216 |
| First boundary line | 21a |
| Second boundary line | 21b |
| Third boundary line | 21c |
| Fourth boundary line | 21d |
| Second electrode plate | 22 |
| Second current collector | 221 |
| Third surface | 221a |
| Fourth surface | 221b |
| Second coated region | 2211 |
| Second region | 221c |
| Fourth coated region | 2212 |
| Second uncoated region | 2213 |
| Second active material layer | 222 |
| Second protrusion | 223 |
| Second recess | 224 |
| Fourth protrusion | 225 |
| Fourth recess | 226 |
| Separator | 23 |
| Apparatus body | 200 |
| Electronic apparatus | 1000 |
| First direction | X |
| Second direction | Y |
| Third direction | Z |

### DETAILED DESCRIPTION

The technical solutions in some embodiments of this application will be described below with reference to the drawings in some embodiments of this application. It is apparent that the described embodiments are only some embodiments rather than all embodiments of this application.

It should be noted that when a component is considered to be “connected” to another component, it may be directly connected to the another component, or there may be an intervening component. When a component is considered to be “provided on” another component, it may be directly provided on the another component, or there may be an intervening component.

Unless otherwise specified, the term “multiple” used herein refers to two or more.

The terms “first”, “second”, and the like appearing herein are only used to distinguish different objects and should not be construed as indicating or implying relative importance, or implying the number, specific order, or primary-secondary relationship of the indicated technical features.

The term “perpendicular” used herein is used to describe an ideal state between two components. In actual production or use, an approximately perpendicular state may exist between the two components. For example, in conjunction with numerical descriptions, perpendicular may mean that an angle between two lines ranges from 90°±10°, perpendicular may mean that a dihedral angle between two planes ranges from 90°±10°, or perpendicular may mean that an angle between a line and a plane ranges from 90°±10°.

It should be noted that when a parameter is greater than, equal to, or less than a specific endpoint value, it should be understood that the endpoint value allows a tolerance of ±10%. For example, if A is greater than 10 compared to B, it should be understood as a case where A is greater than 9 compared to B, as well as a case where A is greater than 11 compared to B.

It should be recognized that the dimensions of layers, regions, films, plates, blocks, columns, protrusions, recesses, and the like shown in the drawings are provided for better understanding and ease of description, and this application is not limited to the dimensions shown in the drawings. To make this application clear, elements irrelevant to the description are omitted from the details of this specification.

Unless otherwise defined, all technical and scientific terms used herein have the same meaning as commonly understood by those skilled in the technical field of this application. The terms used in the specification of this application are only for the purpose of describing specific embodiments and are not intended to limit this application.

This application discloses a secondary battery. The secondary battery includes a housing and an electrode assembly. The electrode assembly is accommodated in the housing, the electrode assembly is bent toward a first direction, and the electrode assembly includes a first electrode plate and a second electrode plate. The first electrode plate includes a first current collector and a first active material layer arranged in a stacked manner, where along a thickness direction of the first electrode plate, the first current collector includes a first surface and a second surface opposite each other. The first current collector includes a first coated region, where the first surface and the second surface of the first coated region are each provided with the first active material layer. The second electrode plate includes a second current collector and a second active material layer arranged in a stacked manner. Multiple first protrusions are formed on a surface of the first electrode plate, and the multiple first protrusions are located in the first coated region.

The first protrusions are located in the first coated region, which may disperse the stress of the bent first electrode plate, suppressing deformation and rebound of the first electrode plate, thereby helping to maintain the bent shape of the first electrode plate, reducing the risk of generation of a large gap between the first electrode plate and the second electrode plate and the risk of generation of black spots in the electrode assembly, and improving the reliability of the electrode assembly. Additionally, suppressing deformation and rebound of the first electrode plate is also conducive to addressing deformation issues such as reduced overall curvature or flattening of the electrode assembly, which helps to reduce the reserved space for the battery compartment accommodating the secondary battery, thereby facilitating the installation of the secondary battery and improving the reliability and applicability of the secondary battery.

Some embodiments of this application will be described below with reference to the drawings. In the absence of conflict, the following embodiments and features in these embodiments can be combined with each other.

Referring to FIG. 1, an embodiment of this application provides a secondary battery 100. The secondary battery 100 includes a housing 10 and an electrode assembly 20, the electrode assembly 20 is accommodated in the housing 10, and the electrode assembly 20 is bent toward a first direction X. The first direction X is a bending direction of the electrode assembly 20, and the first direction X is defined as a direction from a recessed side to a protruding side of the electrode assembly 20 after bending.

In some embodiments, the housing 10 is a flexible packaging bag, such as an aluminum-plastic film. In some other embodiments, the housing 10 is a hard housing, such as a plastic housing, or a metal housing including at least one of steel alloy, aluminum alloy, or copper alloy.

In some embodiments, an electrolyte (not shown in the figure) may be injected into the housing 10, and components of the electrolyte include a solvent, a lithium salt, and an additive.

In some embodiments, referring to FIG. 1, the electrode assembly 20 includes a first electrode plate 21 and a second electrode plate 22, where the first electrode plate 21 and the second electrode plate 22 have opposite polarities. For example, the first electrode plate 21 is an anode electrode plate, and the second electrode plate 22 is a cathode electrode plate. Alternatively, the first electrode plate 21 is a cathode electrode plate, and the second electrode plate 22 is an anode electrode plate.

In some embodiments, referring to FIG. 1, the first electrode plate 21 and the second electrode plate 22 are stacked along the first direction X to form a laminated structure, and the laminated structure formed by the first electrode plate 21 and the second electrode plate 22 is bent toward the first direction X.

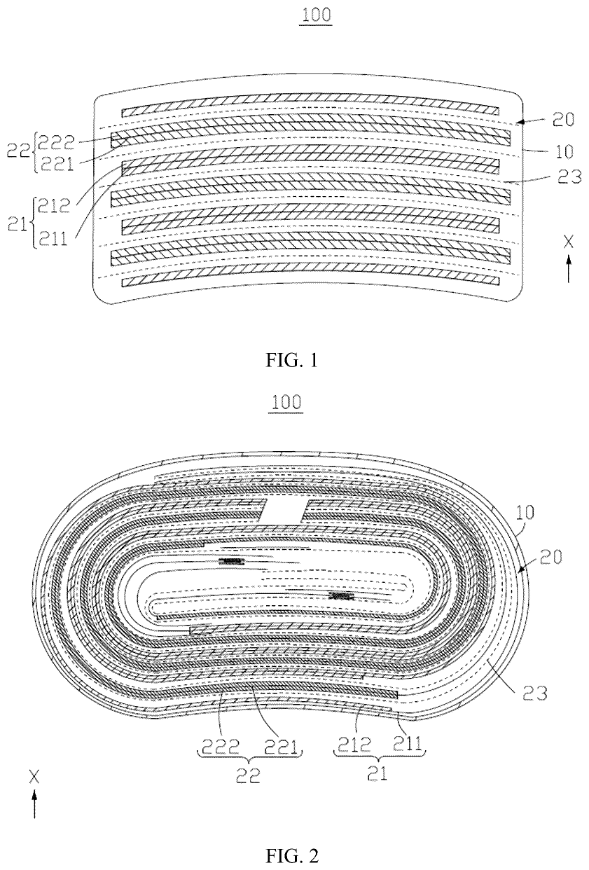

In some other embodiments, referring to FIG. 2, the first electrode plate 21 and the second electrode plate 22 are stacked and wound to form a wound structure.

In some embodiments, referring to FIG. 1 and FIG. 2, the electrode assembly 20 further includes a separator 23, the separator 23 is provided between the first electrode plate 21 and the second electrode plate 22, and the separator 23 is configured to isolate the first electrode plate 21 from the second electrode plate 22.

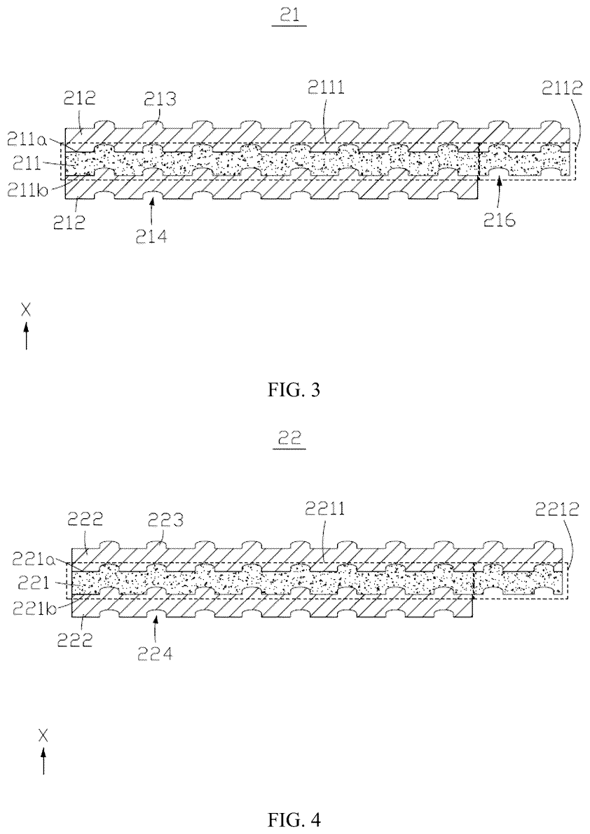

In some embodiments, referring to FIG. 3, the first electrode plate 21 includes a first current collector 211 and a first active material layer 212 arranged in a stacked manner. In a flattened state of the first electrode plate 21, along a thickness direction of the first electrode plate 21, the first current collector 211 includes a first surface 211a and a second surface 211b opposite each other. The first current collector 211 includes a first coated region 2111, where the first surface 211a and the second surface 211b of the first coated region 2111 are each provided with the first active material layer 212. The first coated region 2111 is a double-sided coated region.

In some embodiments, referring to FIG. 4, the second electrode plate 22 includes a second current collector 221 and a second active material layer 222 arranged in a stacked manner. In a flattened state of the second electrode plate 22, along a thickness direction of the second electrode plate 22, the second current collector 221 includes a third surface 221a and a fourth surface 221b opposite each other. The second current collector 221 includes a second coated region 2211, where the third surface 221a and the fourth surface 221b of the second coated region 2211 are each provided with the second active material layer 222. The second coated region 2211 is a double-sided coated region.

In some embodiments, referring to FIG. 3, the first current collector 211 further includes a third coated region 2112, where the first surface 211a of the third coated region 2112 is provided with the first active material layer 212, and the second surface 211b of the third coated region 2112 is not provided with the first active material layer 212. The third coated region 2112 is a single-sided coated region.

In some embodiments, referring to FIG. 4, the second current collector 221 further includes a fourth coated region 2212, where the third surface 221a of the fourth coated region 2212 is provided with the second active material layer 222, and the fourth surface 221b of the fourth coated region 2212 is not provided with the second active material layer 222. The fourth coated region 2212 is a single-sided coated region.

In some embodiments, the first electrode plate 21 and the second electrode plate 22 are arranged as a wound structure, and the second current collector 221 further includes a second uncoated region 2213, where neither the third surface 221a nor the fourth surface 221b of the second uncoated region 2213 is provided with the second active material layer 222. The second uncoated region 2213 is an uncoated foil region.

In an example in which the first electrode plate 21 is an anode electrode plate and the second electrode plate 22 is a cathode electrode plate, the first current collector 211 and the second current collector 221 may be metal layers. The first current collector 211 may be a metal layer including at least one of copper, nickel, tantalum, or titanium, such as copper foil. The second current collector 221 may be a metal layer including at least one of aluminum, nickel, tantalum, or titanium, such as aluminum foil.

In an example in which the first electrode plate 21 is an anode electrode plate and the second electrode plate 22 is a cathode electrode plate, the first active material layer 212 is an anode in terms of polarity, the first active material layer 212 includes an anode active material, and the anode active material may include at least one of graphite, hard carbon, soft carbon, silicon, silicon-oxygen material, or silicon-carbon material. The second active material layer 222 is a cathode in terms of polarity, the second active material layer 222 includes a cathode active material, and the cathode active material may include at least one of lithium cobalt oxide, lithium nickel cobalt manganese oxide, lithium nickel cobalt aluminum oxide, lithium iron phosphate, lithium manganese iron phosphate, or lithium manganese oxide.

In some embodiments, referring to FIG. 3, multiple first protrusions 213 are formed on a surface of the first electrode plate 21, and the multiple first protrusions 213 are located in the first coated region 2111. The multiple first protrusions 213 being located in the first coated region 2111 can be understood as, in a flattened state of the first electrode plate 21, when observed along the thickness direction of the first electrode plate 21, the first protrusions 213 are located within the first coated region 2111.

In the related art, the electrode assembly 20 of an arc-shaped secondary battery 100 is bent, and the first electrode plate 21 and the second electrode plate 22 of the electrode assembly 20 are bent, and the active materials on the first electrode plate 21 and the second electrode plate 22 are compressed or stretched accordingly. After the compressed or stretched active materials release stress, the first electrode plate 21 and the second electrode plate 22 tend to deform and rebound. It is found through research that deformation and rebound of the first electrode plate 21 and the second electrode plate 22 easily cause an excessive gap between the first electrode plate 21 and the second electrode plate 22, or lead to generation of black spots on an outermost layer of the electrode assembly 20.

In this application, the first protrusions 213 are provided on the first electrode plate 21, and the first protrusions 213 are located in the first coated region 2111, which may disperse the stress of the bent first electrode plate 21, suppressing deformation and rebound of the first electrode plate 21, thereby helping to maintain the bent shape of the first electrode plate 21, reducing the risk of generation of a large gap between the first electrode plate 21 and the second electrode plate 22 and the risk of generation of black spots in the electrode assembly 20, and improving the reliability of the electrode assembly 20. Additionally, the first protrusions 213 suppressing deformation and rebound of the first electrode plate 21 is also conducive to addressing deformation issues such as reduced overall curvature or flattening of the electrode assembly 20. When the overall curvature of the electrode assembly 20 remains substantially unchanged, the secondary battery 100 is less likely to undergo significant deformation, and the reserved space for the battery compartment accommodating the secondary battery 100 can be reduced, thereby facilitating the installation of the secondary battery 100 and improving the reliability and applicability of the secondary battery 100.

It can be understood that when the gap between the first electrode plate 21 and the second electrode plate 22 is too large and thus causes electrolyte depletion, black spots may appear in the electrode assembly 20. The presence of black spots can be verified by disassembling the secondary battery 100 and observing the appearance of the electrode assembly 20.

In some embodiments, referring to FIG. 4, multiple second protrusions 223 are formed on a surface of the second electrode plate 22, and the multiple second protrusions 223 are located in the second coated region 2211. The second protrusions 223 may disperse the stress of the bent second electrode plate 22, suppressing deformation and rebound of the second electrode plate 22, thereby helping to maintain the bent shape of the second electrode plate 22. The tendency of deformation and rebound of both the first electrode plate 21 and the second electrode plate 22 is suppressed, which helps to further reduce the risk of generation of an excessive gap between the first electrode plate 21 and the second electrode plate 22 and the risk of generation of black spots in the electrode assembly 20, thereby further improving the reliability of the electrode assembly 20.

In some embodiments, the first protrusion 213 is formed by subjecting the first electrode plate 21 to an embossing process, and the second protrusion 223 is formed by subjecting the second electrode plate 22 to an embossing process.

An example in which the first electrode plate 21 is formed through an embossing process is used for describing the embossing process: the embossing process for the first electrode plate 21 involves bringing one side of the first electrode plate 21 into contact with a rubber-coated roller, and bringing the opposite side of the first electrode plate 21 into contact with an embossing roller having protrusions. The embossing roller applies pressure to the first electrode plate 21, causing the side of the first electrode plate 21 in contact with the rubber-coated roller to protrude, forming the first protrusion 213. The method of forming the first protrusion 213 and the second protrusion 223 through the embossing process is conducive to improving the efficiency of forming the first protrusion 213.

In some embodiments, referring to FIG. 3 and FIG. 4, the first protrusion 213 is formed by subjecting the first electrode plate 21 to an embossing process, and a first recess 214 is formed on a surface of the first electrode plate 21 facing away from the first protrusion 213. The second protrusion 223 is formed by subjecting the second electrode plate 22 to an embossing process, and a second recess 224 is formed on a surface of the second electrode plate 22 facing away from the second protrusion 223.

In some embodiments, the first protrusion 213 and the second protrusion 223 protrude toward the first direction X.

In some embodiments, the first protrusion 213 and the second protrusion 223 protrude in a direction opposite to the first direction X.

In some embodiments, one of the first protrusion 213 and the second protrusion 223 protrudes toward the first direction X, and the other protrudes in a direction opposite to the first direction X.

In some other embodiments, the first protrusion 213 and the second protrusion 223 may be formed by performing other processes on the first electrode plate 21, for example, connecting protrusions made of a same material as the first current collector to the first current collector to form the first protrusion 213 and the second protrusion 223.

In some embodiments, referring to FIG. 3 to FIG. 5, along the first direction X, the electrode assembly 20 includes a first portion 20a and a second portion 20b arranged sequentially, and the multiple first protrusions 213 are located in the first coated region 2111 of the second portion 20b.

Along the first direction X, the second portion 20b is closer to the protruding side of the bent electrode assembly 20 than the first portion 20a. In the bent electrode assembly 20, the first electrode plate 21 closer to the protruding side of the electrode assembly 20 experiences greater stress and is more prone to deformation and rebound. Providing the first protrusions 213 on the first electrode plate 21 closer to the protruding side of the electrode assembly 20 helps to provide a more significant effect of suppressing flattening of the electrode assembly 20.

It can be understood that when the first electrode plate 21 and the second electrode plate 22 form a laminated structure, the second portion 20b includes one or more independent layers of first electrode plates 21; and when the first electrode plate 21 and the second electrode plate 22 form a wound structure, the second portion 20b includes a part or multiple spaced-apart parts of the first electrode plate 21. For example, along the first direction X, the second portion 20b includes a flat segment of the outermost layer of first electrode plate 21 closer to the protruding side of the electrode assembly 20, and the second portion 20b further includes a flat segment of the second outermost layer of first electrode plate 21 closer to the protruding side of the electrode assembly 20.

In some embodiments, the first protrusions 213 are not located in the first coated region 2111 of the second portion 20b. Such arrangement allows the first protrusions 213 to be located on a part of the first electrode plate 21 that is more prone to flattening, while the arrangement of providing no first protrusion 213 on a part of the first electrode plate 21 that is less prone to flattening reduces process steps and improves production efficiency.

In some other embodiments, multiple first protrusions 213 are located in both the first portion 20a and the second portion 20b, increasing a distribution area of the first protrusions 213, thereby helping to further suppress deformation and rebound of the first electrode plate 21.

In some embodiments, referring to FIG. 3 to FIG. 5, multiple second protrusions 223 are located in the second coated region 2211 of the second portion 20b. In the bent electrode assembly 20, the second electrode plate 22 closer to the protruding side of the electrode assembly 20 experiences greater stress and is more prone to deformation and rebound. The multiple second protrusions 223 being located in the second coated region 2211 of the second portion 20b allows the second protrusions 223 to be provided on the second electrode plate 22 closer to the protruding side of the electrode assembly 20, thereby helping to provide a more significant effect of suppressing flattening of the electrode assembly 20.

It can be understood that when the first electrode plate 21 and the second electrode plate 22 form a laminated structure, the second portion 20b includes one or more independent layers of second electrode plates 22; and when the first electrode plate 21 and the second electrode plate 22 form a wound structure, the second portion 20b includes a part or multiple spaced-apart parts of the second electrode plate 22. For example, along the first direction X, the second portion 20b includes a flat segment of the outermost layer of second electrode plate 22 closer to the protruding side of the electrode assembly 20, and the second portion 20b further includes a flat segment of the second outermost layer of second electrode plate 22 closer to the protruding side of the electrode assembly 20.

In some embodiments, the second protrusions 223 are not located in the second coated region 2211 of the second portion 20b. Such arrangement allows the second protrusions 223 to be provided on a part of the second electrode plate 22 that is more prone to flattening, while the arrangement of providing no second protrusion 223 on a part of the second electrode plate 22 that is less prone to flattening reduces process steps and improves production efficiency.

In some other embodiments, multiple second protrusions 223 are located in both the first portion 20a and the second portion 20b, increasing a distribution area of the second protrusions 223, thereby helping to further suppress deformation and rebound of the second electrode plate 22.

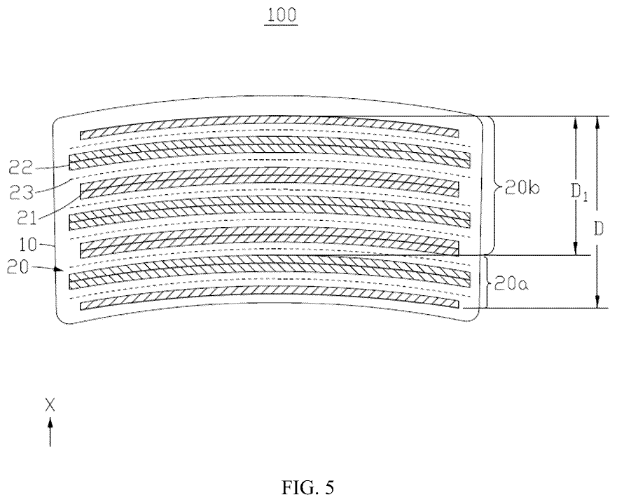

In some embodiments, referring to FIG. 3 and FIG. 5, multiple first protrusions 213 are located in the first coated region 2111 of the second portion 20b, and along the first direction X, a thickness of the electrode assembly 20 is D, and a thickness of the second portion 20b is D₁, satisfying 3×D/4≤D₁≤D. Such arrangement can increase the thickness of the electrode assembly 20 occupied by the first electrode plate 21 provided with the first protrusions 213, which is conducive to further suppressing deformation of the electrode assembly 20 after bending, thereby reducing the risk of reduced curvature or flattening of the electrode assembly 20.

In some embodiments, referring to FIG. 4 and FIG. 5, multiple second protrusions 223 are located in the second coated region 2211 of the second portion 20b, and along the first direction X, a thickness of the electrode assembly 20 is D, and a thickness of the second portion 20b is D₁, satisfying 3×D/4≤D₁≤D. Such arrangement can increase the thickness of the electrode assembly 20 occupied by the second electrode plate 22 provided with the second protrusions 223, which is conducive to further suppressing deformation of the electrode assembly 20 after bending, thereby reducing the risk of reduced curvature or flattening of the electrode assembly 20.

In some embodiments, referring to FIG. 3 to FIG. 5, the multiple first protrusions 213 are located in the first coated region 2111 of the second portion 20b, and the multiple second protrusions 223 are located in the second coated region 2211 of the second portion 20b, satisfying 3×D/4≤D₁≤D. Such arrangement allows the thickness of the electrode plates provided with the first protrusions 213 and the second protrusions 223 to account for at least ¾ of the thickness of the electrode assembly 20, which is conducive to further suppressing deformation of the electrode assembly 20 after bending, thereby reducing the risk of reduced curvature or flattening of the electrode assembly 20.

In some embodiments, the first electrode plate 21 and the second electrode plate 22 form a laminated structure, and the first protrusions 213 may be provided on any one or more layers of first electrode plates 21, and the second protrusions 223 may be provided on any one or more layers of second electrode plates 22. Specific arrangements are not listed one by one.

In some other embodiments, the first electrode plate 21 and the second electrode plate 22 form a wound structure, and the first protrusions 213 may be provided on any part or multiple discontinuous parts of the first electrode plate 21, and the second protrusions 223 may be provided on any part or multiple discontinuous parts of the second electrode plate 22. Specific arrangements are not listed one by one.

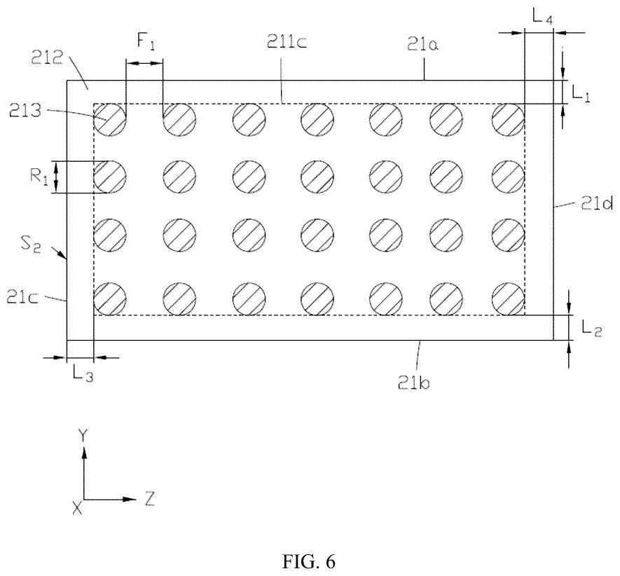

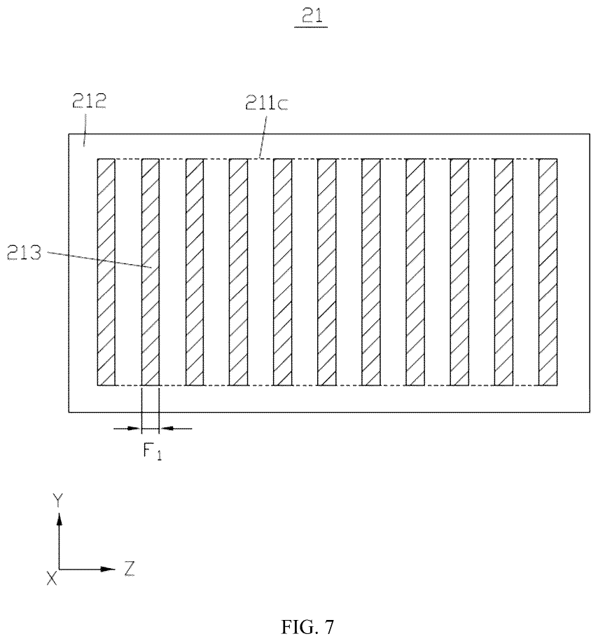

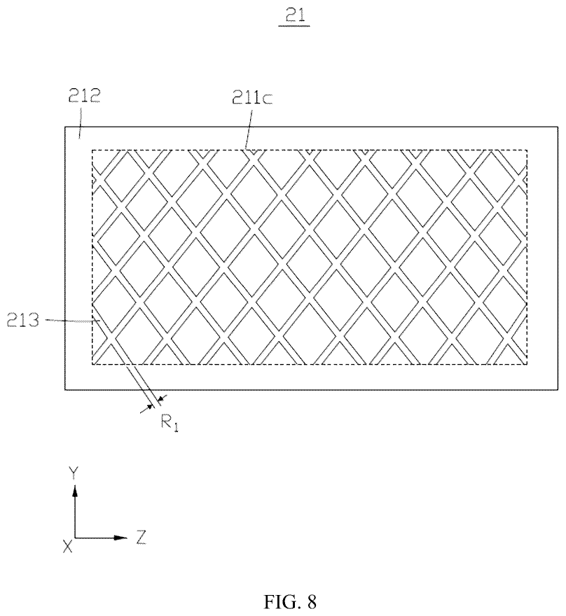

In some embodiments, referring to FIG. 6 to FIG. 8, the first protrusions 213 are one of shapes of dotted protrusions, textured protrusions, and striped protrusions.

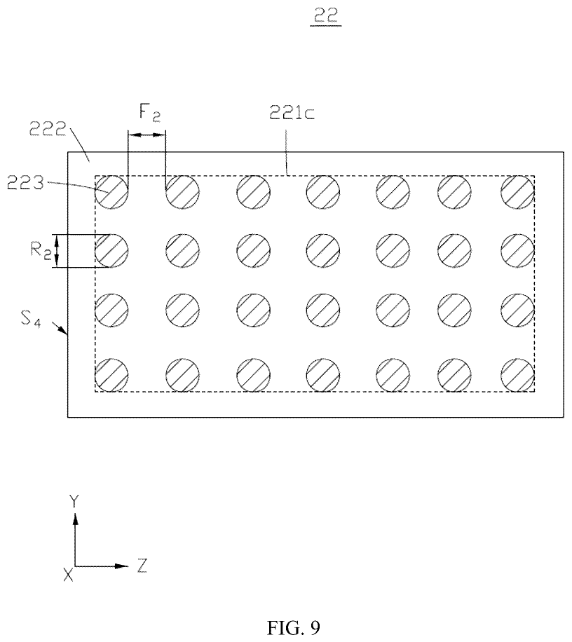

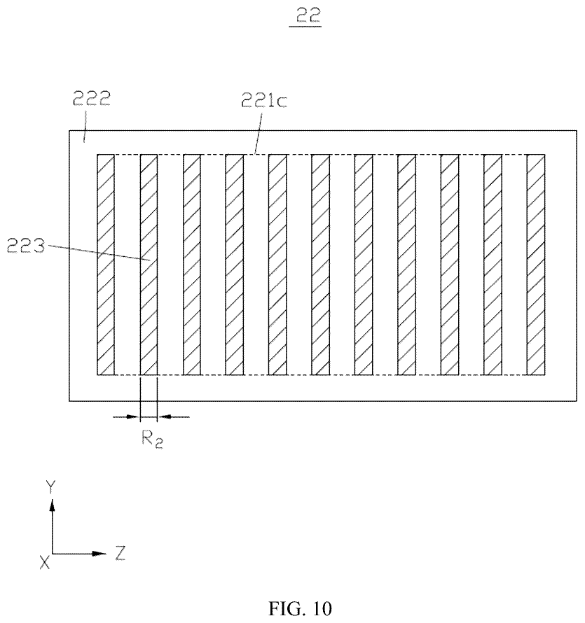

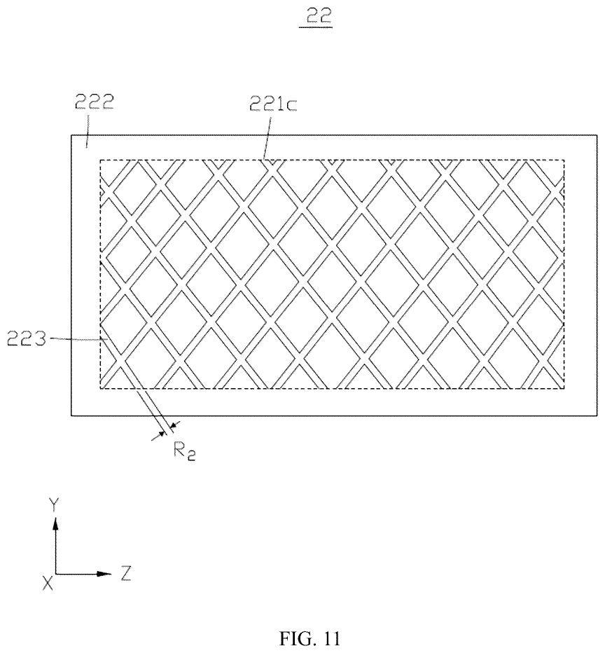

In some embodiments, referring to FIG. 9 to FIG. 11, the second protrusions 223 are in one of shapes of dotted protrusions, textured protrusions, and striped protrusions.

The first protrusions 213 and the second protrusions 223 may be formed through embossing of an embossing roller. For example, a spherical embossing roller with spherical protrusions on the surface may be used to form dotted protrusions on the first electrode plate 21 through embossing, and a spherical embossing roller may be used to form dotted protrusions on the second electrode plate 22 through embossing. A mesh embossing roller with mesh-like protrusions on the surface may be used to form textured protrusions on the first electrode plate 21 through embossing, and a mesh embossing roller may be used to form textured protrusions on the second electrode plate 22 through embossing. A striped embossing roller with striped protrusions on the surface may be used to form striped protrusions on the first electrode plate 21 through embossing, and a striped embossing roller may be used to form striped protrusions on the second electrode plate 22 through embossing.

In some embodiments, referring to FIG. 6 and FIG. 9, the first protrusions 213 are shaped as dotted protrusions, and the second protrusions 223 are shaped as dotted protrusions. Compared to protrusions in other shapes, dotted protrusions are less likely to cause damage to the first active material layer 212 of the first electrode plate 21 and the second active material layer 222 of the second electrode plate 22, which is conducive to improving the reliability of the electrode assembly 20.

In some embodiments, referring to FIG. 6 to FIG. 11, the shape of the first protrusions 213 is different from the shape of the second protrusions 223, allowing patterns of the first protrusions 213 and the second protrusions 223 with different shapes to be staggered, which is conducive to increasing the friction between the first electrode plate 21, the second electrode plate 22, and the separator 23, suppressing the risk of slippage of the first electrode plate 21 and the second electrode plate 22, thereby further improving the reliability of the electrode assembly.

For example, one of the first protrusion 213 and the second protrusion 223 is set as a dotted protrusion, and the other of the first protrusion 213 and the second protrusion 223 is set as a textured protrusion.

In another example, one of the first protrusion 213 and the second protrusion 223 is set as a dotted protrusion, and the other of the first protrusion 213 and the second protrusion 223 is set as a striped protrusion.

In yet another example, one of the first protrusion 213 and the second protrusion 223 is set as a striped protrusion, and the other of the first protrusion 213 and the second protrusion 223 is set as a textured protrusion.

In some embodiments, referring to FIG. 6 to FIG. 8, the first coated region 2111 includes a first region 211c provided with the first protrusions 213; and in a flattened state of the first electrode plate 21, the first electrode plate 21 has a first boundary line 21a and a second boundary line 21b opposite each other along a second direction Y, and the first electrode plate 21 has a third boundary line 21c and a fourth boundary line 21d opposite each other along a third direction Z, where the first direction X, the second direction Y, and the third direction Z are perpendicular to each other.

In some embodiments, a minimum distance between the first region 211c and the first boundary line 21a is L₁, and a minimum distance between the first region 211c and the second boundary line 21b is L₂, satisfying: 1 mm≤L₁≤7 mm and 1 mm≤L₂≤7 mm, which is conducive to reducing the risk of the embossing roller pressing onto a cut-off position of the first electrode plate 21 in the second direction Y, thereby reducing the risk of damage to the first electrode plate 21.

In an illustrative example, L₁ may specifically be 1 mm, 2 mm, 3 mm, 4 mm, 5 mm, 6 mm, or 7 mm, and L₂ may specifically be 1 mm, 2 mm, 3 mm, 4 mm, 5 mm, 6 mm, or 7 mm.

In some embodiments, a minimum distance between the first region 211c and the third boundary line 21c is L₃, and a minimum distance between the first region 211c and the fourth boundary line 21d is L₄, satisfying: 1 mm≤L₃≤7 mm and 1 mm≤L₄≤7 mm, which is conducive to reducing the risk of the embossing roller pressing onto a cut-off position of the first electrode plate 21 in the third direction Z, thereby reducing the risk of damage to the first electrode plate 21.

In an illustrative example, L₃ may specifically be 1 mm, 2 mm, 3 mm, 4 mm, 5 mm, 6 mm, or 7 mm, and L₄ may specifically be 1 mm, 2 mm, 3 mm, 4 mm, 5 mm, 6 mm, or 7 mm.

In some embodiments, referring to FIG. 6, in a flattened state of the first electrode plate 21, when observed along the first direction X, a total area of the multiple first protrusions 213 is S₁, and an area of the first electrode plate 21 is S₂, satisfying: S₁≥0.06×S₂. The total area S₁ of the multiple first protrusions 213 satisfying this condition is conducive to enhancing the dispersion effect of the multiple first protrusions 213 on the overall stress of the first electrode plate 21, thereby enhancing the suppression of deformation of the first electrode plate 21 after bending. In an illustrative example, S₁=0.12×S₂.

In some embodiments, referring to FIG. 9 to FIG. 11, the second coated region 2211 includes a second region 221c provided with the second protrusions 223. Distances from the second region 221c to the boundary lines of the second electrode plate 22 in the second direction Y and the third direction Z may specifically refer to distances from the first region 211c to the first boundary line 21a, the second boundary line 21b, the third boundary line 21c, and the fourth boundary line 21d, and details are not described herein again.

In some embodiments, along a length direction of the first electrode plate 21, a total length of the first electrode plate 21 is greater than a total length of the second electrode plate 22, the first electrode plate 21 is an anode electrode plate, and the second electrode plate 22 is a cathode electrode plate, which is conducive to reducing the risk of lithium precipitation in the electrode assembly 20.

In some embodiments, referring to FIG. 9, in a flattened state of the second electrode plate 22, when observed along the first direction X, a total area of the second protrusions 223 is S₃, and an area of the second electrode plate 22 is S₄, satisfying: S₃≥0.06×S₄. The total area S₃ of the multiple second protrusions 223 satisfying this condition is conducive to enhancing the dispersion effect of the multiple second protrusions 223 on the overall stress of the second electrode plate 22, thereby helping to enhance the suppression of deformation of the second electrode plate 22 after bending. In an illustrative example, S₃=0.12×S₄.

It can be understood that the total area S₁ of the multiple first protrusions 213 refers to a total area of all the first protrusions 213 on the first electrode plate 21. The total area S₁ of the multiple first protrusions 213 may be calculated in a manner as follows: in a flattened state of the first electrode plate 21, an area of a single first protrusion 213 is calculated, and the area of the single first protrusion 213 is multiplied by the number of the first protrusions 213 to obtain the total area S₁ of the multiple first protrusions 213.

The total area S₃ of the multiple second protrusions 223 refers to a total area of all the second protrusions 223 on the second electrode plate 22. The total area S₃ of the multiple second protrusions 223 may be calculated in a manner as follows: in a flattened state of the second electrode plate 22, an area of a single second protrusion 223 is calculated, and the area of the single second protrusion 223 is multiplied by the number of the second protrusions 223 to obtain the total area S₃ of the multiple second protrusions 223.

In some embodiments, referring to FIG. 6, a distance between any two adjacent first protrusions 213 is F₁, satisfying 1.5 mm≤F₁≤3 mm. Satisfying this condition is conducive to dispersing the stress of the first electrode plate 21, further suppressing deformation of the first electrode plate 21 after bending, and reducing the likelihood of generation of black spots in the electrode assembly 20.

In an illustrative example, F₁ may specifically be 1.5 mm, 1.7 mm, 1.9 mm, 2 mm, 2.3 mm, 2.5 mm, 2.7 mm, 2.9 mm, or 3 mm.

In some embodiments, referring to FIG. 9, a distance between any two adjacent second protrusions 223 is F₂, satisfying 1.5 mm≤F₂≤3 mm. Satisfying this condition is conducive to dispersing the stress of the second electrode plate 22, further suppressing deformation of the second electrode plate 22 after bending, and reducing the likelihood of generation of black spots in the electrode assembly 20.

In an illustrative example, F₂ may specifically be 1.5 mm, 1.7 mm, 1.9 mm, 2 mm, 2.3 mm, 2.5 mm, 2.7 mm, 2.9 mm, or 3 mm.

In some embodiments, referring to FIG. 6 to FIG. 8, when observed along the first direction X, a width of the first protrusions 213 is R₁, satisfying R₁≥1 mm. Satisfying this condition is conducive to enhancing the stress dispersion effect of the first protrusions 213 on the first electrode plate 21, thereby further suppressing deformation of the first electrode plate 21 after bending, and reducing the likelihood of generation of black spots in the electrode assembly 20.

In an illustrative example, R₁ may specifically be 1 mm, 1.2 mm, 1.5 mm, 2 mm, 2.3 mm, 2.5 mm, 2.7 mm, 2.9 mm, or 3 mm.

It can be understood that when the first protrusions 213 are dotted protrusions, the first protrusions 213 are circular, and the width R₁ of the first protrusions 213 is the diameter of the first protrusions 213. When the first protrusions 213 are striped protrusions, the length direction of the first protrusions 213 is an extension direction of the striped protrusions, the width direction of the first protrusions 213 is an arrangement direction of the multiple first protrusions 213, and the width R₁ of the first protrusions 213 is the width of the first protrusions 213 along the arrangement direction. When the first protrusions 213 are textured protrusions, a single first protrusion 213 is actually a tilted striped protrusion, the length direction of the first protrusion 213 is an extension direction of the striped protrusion, the width direction of the first protrusion 213 is an arrangement direction of the multiple first protrusions 213, and the width R₁ of the first protrusion 213 is the width of the first protrusion 213 along the arrangement direction.

In some embodiments, referring to FIG. 9 to FIG. 11, when observed along the first direction X, a width of the second protrusions 223 is R₂, satisfying R₂≥1 mm. Satisfying this condition is conducive to enhancing the stress dispersion effect of the second protrusions 223 on the second electrode plate 22, thereby further suppressing deformation of the second electrode plate 22 after bending, and reducing the likelihood of generation of black spots in the electrode assembly 20. Definition of the width R₂ of the second protrusions 223 may refer to definition of the width R₁ of the first protrusions 213, and details are not described herein again.

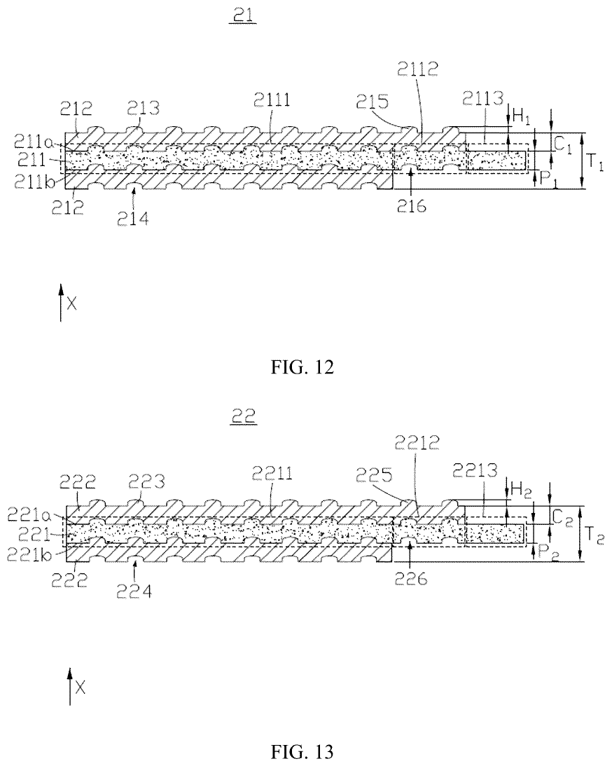

In some embodiments, referring to FIG. 12, along the first direction X, a thickness of the first electrode plate 21 corresponding to the first coated region 2111 is T₁, and a height of the first protrusions 213 is H₁, satisfying 0.01×T₁≤H₁≤0.14×T₁. Satisfying this condition is conducive to enhancing the stress dispersion effect of the first protrusions 213 on the first electrode plate 21, thereby further suppressing deformation of the first electrode plate 21 after bending. Additionally, in some embodiments in which the first protrusions 213 are formed through embossing of an embossing roller, satisfying this condition also helps to reduce the risk of damage to the first electrode plate 21 due to excessive pressure applied to the first electrode plate 21 by the embossing roller, or reduce the risk of damage due to excessive local deformation of the first electrode plate 21.

The thickness T₁ of the first electrode plate 21 corresponding to the first coated region 2111 is a sum of thicknesses of the first current collector 211 of the first coated region 2111, the first active material layer 212 on the first surface 211a, and the first active material layer 212 on the second surface 211b. The height H₁ of the first protrusions 213 refers to a maximum height of the multiple first protrusions 213.

In some embodiments, referring to FIG. 13, along the first direction X, a thickness of the second electrode plate 22 corresponding to the second coated region 2211 is T₂, and a height of the second protrusions 223 is H₂, satisfying 0.01×T₂≤H₂≤0.14×T₂. Satisfying this condition is conducive to enhancing the stress dispersion effect of the second protrusions 223 on the second electrode plate 22, thereby further suppressing deformation of the second electrode plate 22 after bending. Additionally, in some embodiments in which the second protrusions 223 are formed through embossing of an embossing roller, satisfying this condition also helps to reduce the risk of damage to the second electrode plate 22 due to excessive pressure applied to the second electrode plate 22 by the embossing roller, or reduce the risk of damage due to excessive local deformation of the second electrode plate 22.

The thickness T₂ of the second electrode plate 22 corresponding to the second coated region 2211 is a sum of thicknesses of the second current collector 221 of the second coated region 2211, the second active material layer 222 on the third surface 221a, and the second active material layer 222 on the fourth surface 221b. The height H₂ of the second protrusions 223 refers to a maximum height of the multiple second protrusions 223.

In an example in which the first electrode plate 21 is an anode electrode plate and the second electrode plate 22 is a cathode electrode plate, the height H₁ of the first protrusions 213 is equal to 0.01×T₁, and the height H₂ of the second protrusions 223 is equal to 0.14×T₂.

In some embodiments, referring to FIG. 12 and FIG. 13, along the first direction X, a thickness of the first current collector 211 is P₁, satisfying: 4 um≤P₁≤16 um; a thickness of the second current collector 221 is P₂, satisfying 8 um≤P₂≤16 um; a thickness of the first active material layer 212 is C₁, satisfying 50 um≤C₁≤200 um; and a thickness of the second active material layer 222 is C₂, satisfying 50 um≤C₂≤200 um.

In an illustrative example, P₁ may specifically be 4 um, 6 um, 8 um, 10 um, 12 um, 14 um, or 16 um. P₂ may specifically be 8 um, 10 um, 12 um, 14 um, or 16 um. C₁ may specifically be 50 um, 60 um, 70 um, 80 um, 100 um, 120 um, 140 um, 160 um, 170 um, 180 um, 190 um, or 200 um. C₂ may specifically be 50 um, 60 um, 70 um, 80 um, 100 um, 120 um, 140 um, 160 um, 170 um, 180 um, 190 um, or 200 um.

In some embodiments, the first electrode plate 21 is an anode electrode plate, the first current collector 211 is a copper foil, the first active material layer 212 is an anode in terms of polarity, and the first active material includes graphite. The second electrode plate 22 is a cathode electrode plate, the second current collector 221 is an aluminum foil, and the second active material includes at least one of lithium cobalt oxide, lithium nickel cobalt manganese oxide, lithium nickel cobalt aluminum oxide, lithium iron phosphate, lithium manganese iron phosphate, or lithium manganese oxide.

During bending of the first electrode plate 21, graphite particles in the first active material layer 212 compress each other, deform, and store stress. After the first electrode plate 21 is bent, the graphite particles release the stress, causing the extension of the graphite particles on the first current collector 211 to be greater than the extension of the copper foil first current collector 211, making the first electrode plate 21 prone to deformation after bending. Providing the first protrusions 213 on the surface of the first electrode plate 21 helps to provide a more significant effect of suppressing flattening of the electrode assembly 20.

In some embodiments, referring to FIG. 12, multiple third protrusions 215 are formed on a surface of the first electrode plate 21, and the multiple third protrusions 215 are located in the third coated region 2112, which can further disperse the stress of the bent first electrode plate 21, suppressing deformation and rebound of the first electrode plate 21, thereby helping to maintain the bent shape of the first electrode plate 21, reducing the risk of generation of a large gap between the first electrode plate 21 and the second electrode plate 22 and the risk of generation of black spots in the electrode assembly 20, and improving the reliability of the electrode assembly 20.

In some embodiments, referring to FIG. 13, multiple fourth protrusions 225 are formed on a surface of the second electrode plate 22, and the multiple fourth protrusions 225 are located in the fourth coated region 2212, which can further disperse the stress of the bent second electrode plate 22, suppressing deformation and rebound of the second electrode plate 22, thereby helping to maintain the bent shape of the second electrode plate 22, reducing the risk of generation of a large gap between the first electrode plate 21 and the second electrode plate 22 and the risk of generation of black spots in the electrode assembly 20, and improving the reliability of the electrode assembly 20.

In some embodiments, referring to FIG. 12 and FIG. 13, the third protrusions 215 are formed by subjecting the first electrode plate 21 to an embossing process, and a third recess 216 is formed on a surface of the first electrode plate 21 facing away from the third protrusions 215. The fourth protrusions 225 are formed by subjecting the second electrode plate 22 to an embossing process, and a fourth recess 226 is formed on a surface of the second electrode plate 22 facing away from the fourth protrusions 225.

In some embodiments, referring to FIG. 12 and FIG. 13, the first electrode plate 21 and the second electrode plate 22 are arranged as a wound structure, and the first current collector 211 further includes a first uncoated region 2113, where neither the first surface 211a nor the second surface 211b of the first uncoated region 2113 is provided with the first active material layer 212. The first uncoated region 2113 is an uncoated foil region.

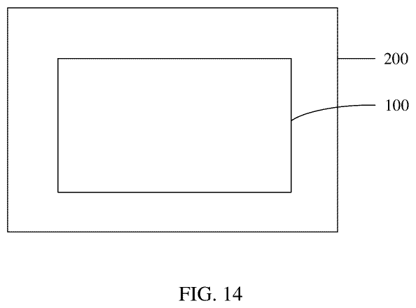

Referring to FIG. 14, an embodiment of this application further provides an electronic apparatus 1000, where the electronic apparatus 1000 includes the secondary battery 100 according to any of the above embodiments.

In some embodiments, the electronic apparatus 1000 may be a mobile phone, a laptop, a tablet computer, a drone, an electric tool, an electric toy, a gaming console, a video recorder, a portable recorder, a radio, a smartwatch, or the like, which is not listed one by one herein.

In some embodiments, the electronic apparatus 1000 further includes an apparatus body 200, and the secondary battery 100 is installed in the apparatus body 200. Since the electronic apparatus 1000 adopts the technical solution of the secondary battery 100 according to any of the above embodiments, the electronic apparatus 1000 at least has the beneficial effects brought by the technical solution of the secondary battery 100 of any of the above embodiments. Details are not described herein again.

In addition, those skilled in the art should recognize that the above embodiments are only used to illustrate this application and are not used to limit this application. As long as they are within the essential scope of this application, all appropriate changes and variations made to the above embodiments fall within the scope of this application.

What is claimed is:

1. A secondary battery, wherein the secondary battery comprises a housing and an electrode assembly, the electrode assembly is accommodated in the housing, the electrode assembly is bent toward a first direction (X); and the electrode assembly comprises:
a first electrode plate, comprising a first current collector and a first active material layer arranged in a stacked manner; wherein along a thickness direction of the first electrode plate, the first current collector comprises a first surface and a second surface opposite to each other, the first current collector comprises a first coated region, and the first surface and the second surface of the first coated region are each provided with the first active material layer; and
a second electrode plate, comprising a second current collector and a second active material layer arranged in a stacked manner;
wherein multiple first protrusions are formed on a surface of the first electrode plate, and the multiple first protrusions are located in the first coated region.

2. The secondary battery according to claim 1, wherein along a thickness direction of the second electrode plate, the second current collector comprises a third surface and a fourth surface opposite to each other, the second current collector comprises a second coated region, and the third surface and the fourth surface of the second coated region are each provided with the second active material layer; and
multiple second protrusions are formed on a surface of the second electrode plate, and the multiple second protrusions are located in the second coated region.

3. The secondary battery according to claim 2, wherein along the first direction (X), the electrode assembly comprises a first portion and a second portion arranged sequentially, and the multiple first protrusions are located in the first coated region of the second portion.

4. The secondary battery according to claim 3, wherein along the first direction (X), a thickness of the electrode assembly is D, a thickness of the second portion is D₁, and 3D/4≤D₁≤D.

5. The secondary battery according to claim 2, wherein the first protrusions are in one of shapes of dotted protrusions, textured protrusions, or striped protrusions; and/or
the second protrusions are in one of shapes of dotted protrusions, textured protrusions, or striped protrusions.

6. The secondary battery according to claim 2, wherein the shape of the first protrusions is different from the shape of the second protrusions.

7. The secondary battery according to claim 1, wherein in a flattened state of the first electrode plate, when observed along the first direction (X), a total area of the multiple first protrusions is S₁, and an area of the first electrode plate is S₂, wherein S₁≥0.06S₂.

8. The secondary battery according to claim 4, wherein in a flattened state of the first electrode plate, when observed along the first direction (X), a total area of the multiple first protrusions is S₁, and an area of the first electrode plate is S₂, wherein S₁≥0.06S₂.

9. The secondary battery according to claim 1, wherein along the first direction (X), a thickness of the first electrode plate corresponding to the first coated region is T₁, and a height of the first protrusions is H₁, wherein 0.01T₁≤H₁≤0.14T₁.

10. The secondary battery according to claim 2, wherein along the first direction (X), a thickness of the first electrode plate corresponding to the first coated region is T₁, and a height of the first protrusions is H₁, wherein 0.01T₁≤H₁≤0.14T₁.

11. The secondary battery according to claim 1, wherein a distance between any two adjacent first protrusions is F₁, and 1.5 mm≤F₁≤3 mm.

12. The secondary battery according to claim 1, wherein when observed along the first direction (X), a width of the first protrusions is R₁, and R₁≥1 mm.

13. The secondary battery according to claim 2, wherein when observed along the first direction (X), a width of the first protrusions is R₁, and R₁≥1 mm.

14. The secondary battery according to claim 1, wherein the first coated region comprises a first region provided with the first protrusions; and in a flattened state of the first electrode plate, the first electrode plate has a first boundary line and a second boundary line opposite to each other along a second direction (Y), and the first electrode plate has a third boundary line and a fourth boundary line opposite to each other along a third direction (Z); wherein the first direction (X), the second direction (Y), and the third direction (Z) are perpendicular to each other;
a minimum distance between the first region and the first boundary line is L₁, and a minimum distance between the first region and the second boundary line is L₂, satisfying 1 mm≤L₁≤7 mm and 1 mm≤L₂≤7 mm; or
a minimum distance between the first region and the third boundary line is L₃, and a minimum distance between the first region and the fourth boundary line is L₄, satisfying 1 mm≤L₃≤7 mm, and 1 mm≤L₄≤7 mm.

15. The secondary battery according to claim 2, wherein the first coated region comprises a first region provided with the first protrusions; and in a flattened state of the first electrode plate, the first electrode plate has a first boundary line and a second boundary line opposite to each other along a second direction (Y), and the first electrode plate has a third boundary line and a fourth boundary line opposite to each other along a third direction (Z); wherein the first direction (X), the second direction (Y), and the third direction (Z) are perpendicular to each other;
a minimum distance between the first region and the first boundary line is L₁, and a minimum distance between the first region and the second boundary line is L₂, satisfying 1 mm≤L₁≤7 mm and 1 mm≤L₂≤7 mm; or
a minimum distance between the first region and the third boundary line is L₃, and a minimum distance between the first region and the fourth boundary line is L₄, satisfying 1 mm≤L₃≤7 mm, 1 mm≤L₄≤7 mm.

16. The secondary battery according to claim 1, wherein the first electrode plate is an anode electrode plate, and the second electrode plate is a cathode electrode plate.

17. The secondary battery according to claim 1, wherein the first current collector further comprises a third coated region, wherein the first surface of the third coated region is provided with the first active material layer, and the second surface of the third coated region is not provided with the first active material layer; and
multiple third protrusions are formed on a surface of the first electrode plate, and the multiple third protrusions are located in the third coated region.

18. The secondary battery according to claim 1, wherein the housing is a packaging bag.

19. An electronic apparatus, comprising the secondary battery according to claim 1.

20. An electronic apparatus, comprising the secondary battery according to claim 14.
